(19) United States
(12) Patent Application Publication
(10) Pub. No.: US 2007/0170913 A1
(43) Pub. Date: Jul. 26, 2007

(54) Magnetic detection apparatus

(75) Inventors: Masahiro Yokotani, Tokyo (JP); Naoki Hiraoka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/414,482

(22) Filed: May 1, 2006

(30) Foreign Application Priority Data
Jan. 25, 2006 (JP) 2006-016485

(51) Int. Cl. G01B 7/14

(52) U.S. Cl. 324/207.22; 324/207.2; 324/207.21

(57) ABSTRACT

A magnetic detection apparatus can reduce the cost of production to a substantially extent. The magnetic detection apparatus includes a magnetic movable element (1) having a first groove (1a) and a second groove (1b) that are different in diametral depth from each other, a magnetoresistive segment (3a) that is arranged apart from the magnetic movable element (1) so as to come in opposition to the first and second grooves (1a, 1b) in accordance with the moving magnetic movable element (1), a magnet (5) that is arranged in the vicinity of the magnetoresistive segment (3a) for applying a magnetic field thereto, and a processing circuit part (4) that generates different output signals in accordance with a change of the magnetic field applied to the magnetoelectric conversion element (3a) which is caused in accordance with the first and second grooves (1a, 1b) in opposition to said processing circuit part (4).

### BACKGROUND OF THE INVENTION

1. Field of the Invention

The present invention relates to a magnetic detection apparatus that detects the movement of a magnetic movable element from a change in the magnetic field applied to a magnetoelectric conversion element.

2. Description of the Related Art

In the past, there has been known a magnetic detection apparatus which includes a magnetic movable element that rotates around a rotation shaft and has a plurality of grooves formed on a peripheral portion thereof at predetermined intervals, a magnetoresistive segment that is arranged at a location apart from the magnetic movable element in a diametral direction, a magnet that is arranged in the vicinity of the magnetoresistive segment for applying a magnetic field to the magnetoresistive segment, and a processing circuit part that generates an output signal corresponding to a change in the magnetic field applied to the magnetoresistive segment (see, for example, a first patent document: Japanese patent application laid-open No. 2005-156368).

In this case, as the rotation shaft rotates, the magnetic movable element also rotates in synchronization with the rotation of the rotation shaft, so that the magnetic field applied to the magnetoresistive segment from the magnet changes between the time when the magnetoresistive segment comes in opposition to a tooth portion formed between adjacent grooves of the magnetic movable element, and the time when the magnetoresistive segment comes in opposition to a groove. The resistance value of the magnetoresistive segment changes in accordance with such a change in the magnetic field, so a signal corresponding to this change in the resistance value is output, whereby the rotational angle of the rotation shaft can be detected.

In the peripheral portion of the magnetic movable element as constructed in the above manner, there are formed the plurality of grooves each having a constant or fixed circumferential width at equal intervals, and hence, when the crank angle and the cam angle of a vehicular engine are to be detected for example, it is necessary to provide two kinds of magnetic detection apparatuses for exclusive use with these purposes, thus posing a problem that the cost of production becomes high.

### SUMMARY OF THE INVENTION

Accordingly, the present invention is intended to obviate the problem as referred to above, and has for its object to obtain a magnetic detection apparatus which is capable of reducing the cost of production to a substantially extent.

Bearing the above object in mind, a magnetic detection apparatus according to the present invention includes a magnetic movable element that has at least two kinds of odd-shape portions of mutually different shapes; a magnetoelectric conversion element that is arranged at a location apart from the magnetic movable element so as to come in opposition to one of the odd-shape portions differing in accordance with the moving magnetic movable element; a magnet that is arranged in the vicinity of the magnetoelectric conversion element for applying a magnetic field to the magnetoelectric conversion element; and a processing circuit part that generates different output signals in accordance with a change of the magnetic field applied to the magnetoelectric conversion element which is caused in accordance with the different odd-shape portions in opposition to the processing circuit part.

According to the magnetic detection apparatus of the present invention, it becomes possible to generate two or more signal outputs with the use of a single magnetic detection apparatus, so the production cost can be reduced greatly.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a perspective view showing a magnetic detection apparatus according to a first embodiment of the present invention.

FIG. 2 is a partial plan view of the magnetic detection apparatus of FIG. 1.

FIG. 3 is an electric circuit diagram of the magnetic detection apparatus of FIG. 1.

FIG. 4 is an operational waveform diagram of the magnetic detection apparatus of FIG. 1.

FIG. 5 is a perspective view showing a magnetic detection apparatus according to a second embodiment of the present invention.

FIG. 6 is a side elevation of the magnetic detection apparatus of FIG. 5 when a magnetic movable element is seen from the back side of a processing circuit part.

FIG. 7 is a perspective view showing a magnetic detection apparatus according to a third embodiment of the present invention.

FIG. 8 is a side elevation of the magnetic detection apparatus of FIG. 7 when a magnetic movable element is seen from the back side of a processing circuit part.

FIG. 9 is a perspective view showing a magnetic detection apparatus according to a fourth embodiment of the present invention.

FIG. 10 is a side elevation of the magnetic detection apparatus of FIG. 9 when a magnetic movable element is seen from the back side of a processing circuit part.

FIG. 11 is a perspective view showing a magnetic detection apparatus according to a fifth embodiment of the present invention.

FIG. 12 is a side elevation of the magnetic detection apparatus of FIG. 11 when a magnetic movable element is seen from the back side of a processing circuit part.

FIG. 13 is an MR loop characteristic view of a GMR element in a magnetic detection apparatus according to a sixth embodiment of the present invention.

### DESCRIPTION OF THE PREFERRED EMBODIMENTS

Now, preferred embodiments of the present invention will be described in detail while referring to the accompanying drawings.

### Embodiment 1

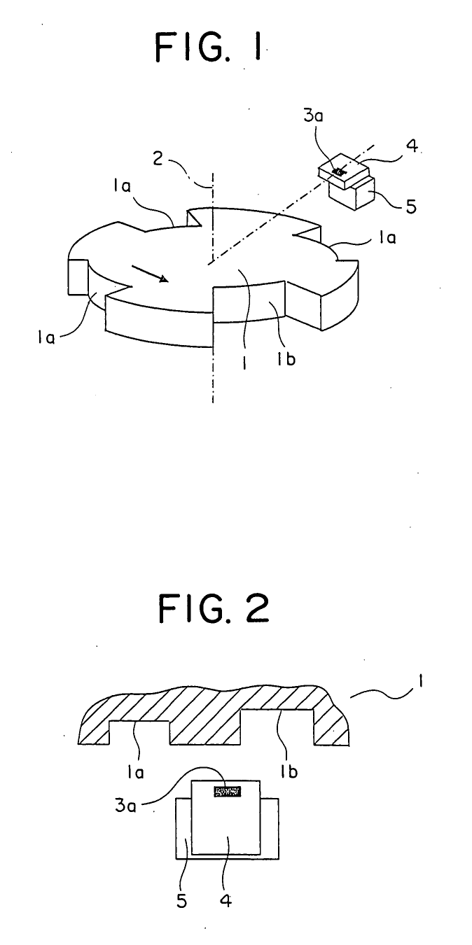

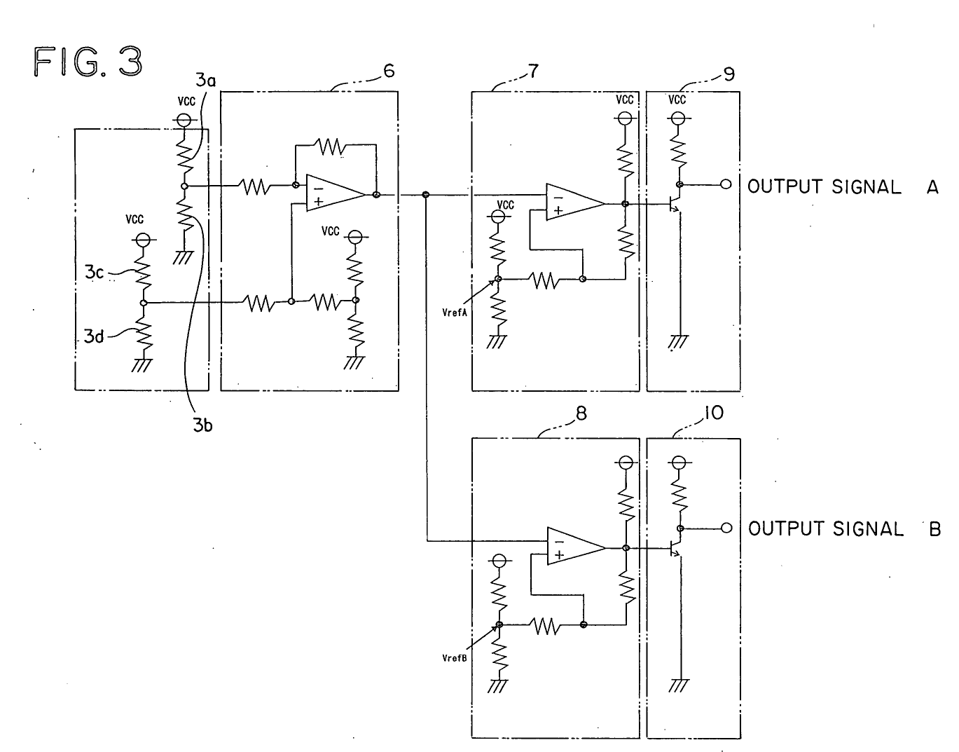

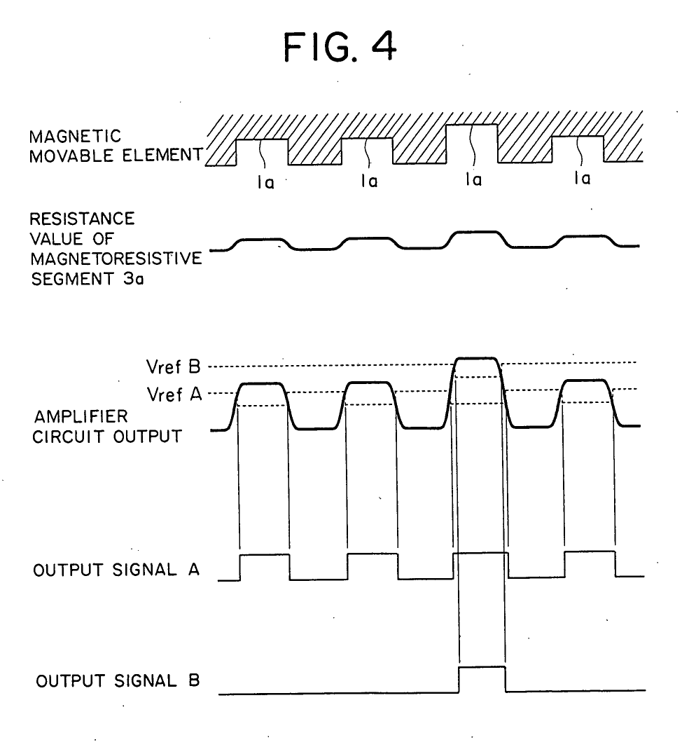

FIG. 1 is a perspective view that shows a magnetic detection apparatus according to a first embodiment of the present invention, and FIG. 2 is a partial plan view of the magnetic detection apparatus of FIG. 1. FIG. 3 is an electric circuit diagram of the magnetic detection apparatus of FIG. 1, and FIG. 4 is an operational waveform diagram of the magnetic detection apparatus of FIG. 1.

The magnetic detection apparatus illustrated in the above figures includes a disk-shaped magnetic movable element 1 that rotates around a rotation shaft 2, a magnetoresistive segment 3a in the form of a magnetoelectric conversion element that is arranged at a location apart from the magnetic movable element 1 in a diametral direction, a processing circuit part 4 with the magnetoresistive segment 3a being arranged on an upper surface thereof, and a magnet 5 that is arranged at a location under the processing circuit part 4.

The processing circuit part 4 includes therein fixed resistors 3b through 3d that cooperate with the magnetoresistive segment 3a to constitute a bridge circuit, a differential amplifier circuit 6 that amplifies an output whose voltage is changed in accordance with a change in resistance of the magnetoresistive segment 3a, a first comparison circuit 7 that shapes the waveform of an output from the differential amplifier circuit 6 by comparing it with a first comparison level, and a first output circuit 9 that outputs an output from the first comparison circuit 7 as an output signal A.

In addition, the processing circuit part 4 also includes therein a second comparison circuit 8 that shapes the waveform of the output from the differential amplifier circuit 6 by comparing it with a second comparison level, and a second output circuit 9 that outputs an output from the second comparison circuit 8 as an output signal B.

First grooves 1a and second grooves 1b, which constitute odd-shape portions, are formed on the peripheral portion of the magnetic movable element 1. The first grooves 1a and the second grooves 1b are arranged at equal intervals. The second grooves 1b are larger in their diametral depth than the first grooves 1a.

In the magnetic detection apparatus as constructed above, with the rotation of the rotation shaft 2, the magnetic movable element 1 also rotates in synchronization therewith, whereby the first grooves 1a and the second grooves 1b of the magnetic movable element 1, being arranged in opposition to the magnetoresistive segment 3a, are continuously changing in their positions in accordance with the rotation of the magnetic movable element 1, so the strength of the magnetic field applied from the magnet 5 to the magnetoresistive segment 3a accordingly changes, too.

As a result, the resistance value of the magnetoresistive segment 3a also continuously changes in accordance with the changing positions of the first grooves 1a and the second grooves 1b of the magnetic movable element 1, as shown in FIG. 4.

In accordance with the change in the resistance value of the magnetoresistive segment 3a, a midpoint voltage between a midpoint between the magnetoresistive segment 3a and the fixed resistor 3b and a midpoint between the fixed resistor 3c and the fixed resistor 3d changes in the bridge circuit to which a constant voltage is applied, and the midpoint voltage is amplified by the differential amplifier circuit 6.

The output from the differential amplifier circuit 6 is input to the first comparison circuit 7 where it is waveform shaped by being compared with a first threshold VrefA, and in this manner, a first output signal A corresponding to the first grooves 1a and the second grooves 1b is output from the first output circuit 9.

Also, the output from the differential amplifier circuit 6 is input to the second comparison circuit 8 where it is waveform shaped by being compared with a second threshold VrefB, and a second output signal B is output from the second output circuit 10.

In this embodiment, the first output signal A is output when one of the first grooves 1a and the second grooves 1b comes in opposition to the magnetoresistive segment 3a, whereas the second output signal B is output only when one of the second grooves 1b comes in opposition to the magnetoresistive segment 3a.

Thus, in the magnetic detection apparatus of this first embodiment, for example, two kinds of angles such as a cam angle and a crank angle can be detected by means of the single magnetic detection apparatus, and hence the position of a piston in each cylinder of an engine can be determined by the output signals A, B, whereby optimal ignition timing can be controlled.

### Embodiment 2

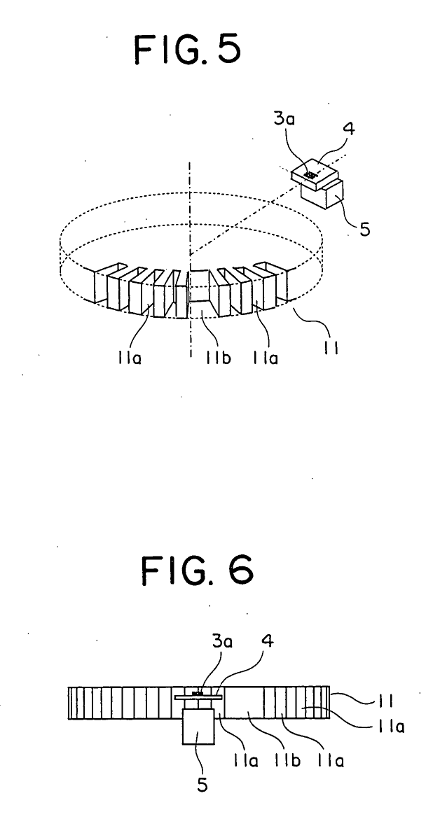

FIG. 5 is a perspective view that shows a magnetic detection apparatus according to a second embodiment of the present invention, and FIG. 6 is a side elevation of the magnetic detection apparatus of FIG. 5 when a magnetic movable element 11 is seen from the back side of a processing circuit part 4.

The magnetic movable element 11 is of a disk shape, and is formed with first grooves 11a and second grooves 11b, which constitute odd-shape portions. The second grooves 11b are larger in their circumferential length than the first grooves 11a.

The construction of this second embodiment other than the above is similar to that of the first embodiment.

In this second embodiment, too, the resistance value of the magnetoresistive segment 3a also continuously changes in accordance with the changing positions of the first grooves 11a and the second grooves 11b of the magnetic movable element 11, so two different output signals are output from the first output circuit 9 and the second output circuit 10, respectably.

### Embodiment 3

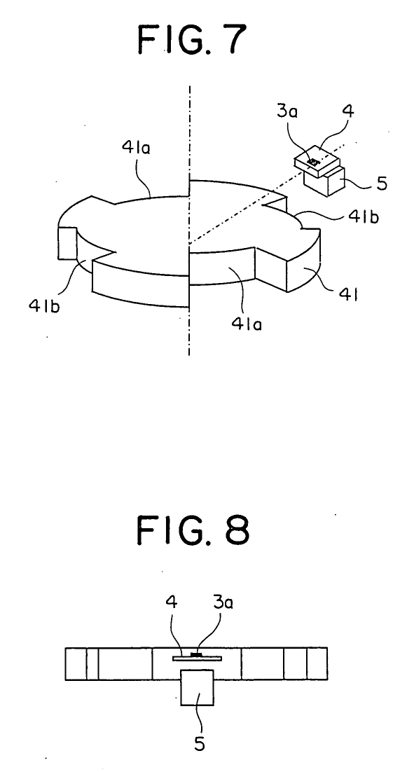

FIG. 7 is a perspective view that shows a magnetic detection apparatus according to a third embodiment of the present invention, and FIG. 8 is a side elevation of the magnetic detection apparatus of FIG. 7 when a magnetic movable element 41 is seen from the back side of a processing circuit part 4.

The magnetic movable element 41 is of a disk shape, and is formed with a pair of first grooves 41a and a pair of second grooves 41b, which constitute odd-shape portions.

The pair of first grooves 41a, being arranged in diametrally opposed relation to each other, are larger in their diametral depth than the pair of second grooves 41b which are also arranged in diametrally opposed relation to each other.

The construction of this third embodiment other than the above is similar to that of the first embodiment.

In this third embodiment, too, the resistance value of the magnetoresistive segment 3a also continuously changes in accordance with the changing positions of the first grooves 41a and the second grooves 41b of the magnetic movable element 41, so two different output signals are output from the first output circuit 9 and the second output circuit 10, respectably.

### Embodiment 4

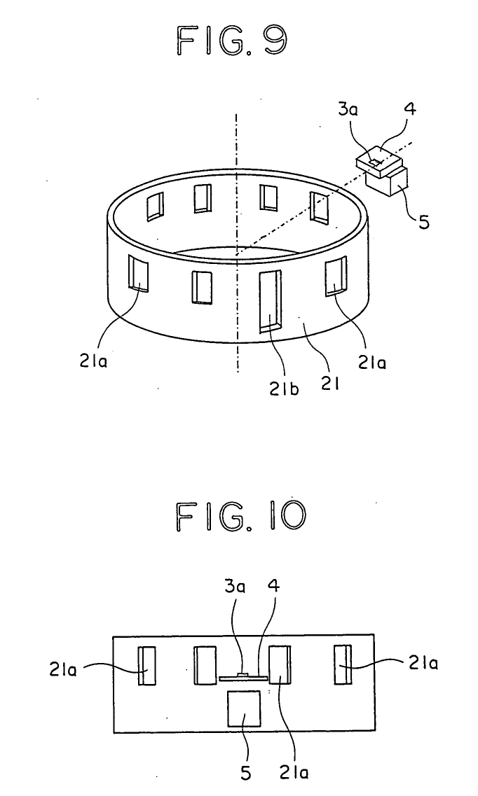

FIG. 9 is a perspective view that shows a magnetic detection apparatus according to a fourth embodiment of the present invention, and FIG. 10 is a side elevation of the magnetic detection apparatus of FIG. 9 when a magnetic movable element 21 is seen from the back side of a processing circuit part 4.

The magnetic movable element 21 is of a cylindrical shape, and has first holes 21a and second holes 21b, which constitute odd-shape portions, formed in its peripheral wall at equal intervals.

The second holes 21b are larger in their axial length than the first holes 21a.

The construction of this fourth embodiment other than the above is similar to that of the first embodiment.

In this fourth embodiment, too, the resistance value of the magnetoresistive segment 3a also continuously changes in accordance with the changing positions of the first holes 21a and the second holes 21b of the magnetic movable element 21, so two different output signals are output from the first output circuit 9 and the second output circuit 10, respectably.

### Embodiment 5

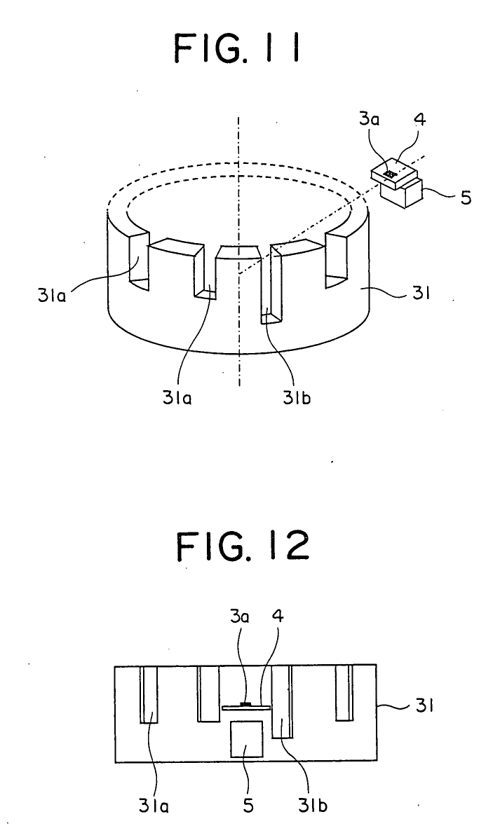

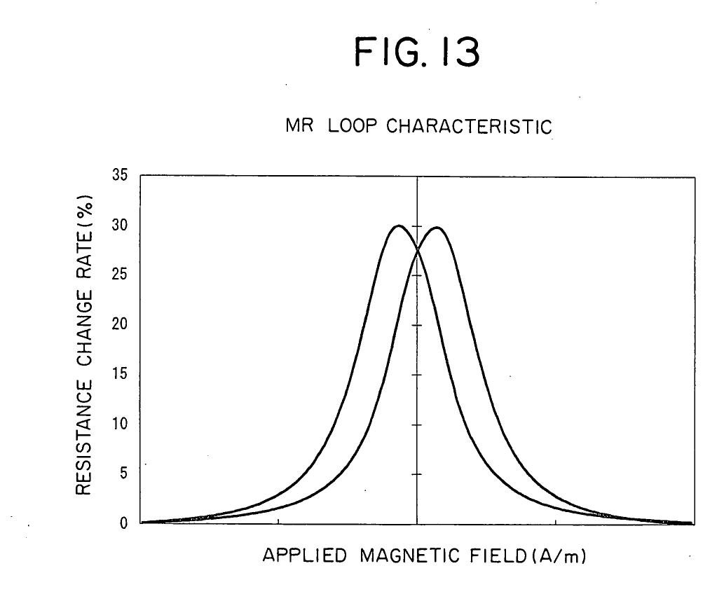

FIG. 11 is a perspective view that shows a magnetic detection apparatus according to a fifth embodiment of the present invention, and FIG. 12 is a side elevation of the magnetic detection apparatus of FIG. 11 when a magnetic movable element 31 is seen from the back side of a processing circuit part 4.

The magnetic movable element 21 is of a cylindrical shape, and has first grooves 31a and second grooves 31b, which constitute odd-shape portions, formed in its peripheral wall at equal intervals.

The first and second grooves 31a, 31b are formed by notching or cutting away the peripheral wall of the magnetic movable element 31 in an axial direction from one end face thereof, and the second grooves 31b are larger in their axial length than the first grooves 31a.

The construction of this fifth embodiment other than the above is similar to that of the first embodiment.

In this fifth embodiment, too, the resistance value of the magnetoresistive segment 3a also continuously changes in accordance with the changing positions of the first grooves 31a and the second grooves 31b of the magnetic movable element 31, so two different output signals are output from the first output circuit 9 and the second output circuit 10, respectably.

### Embodiment 6

A sixth embodiment of the present invention shows an example in which a giant magnetoresistive element (hereinafter simply referred to as a “GMR element”) is used as a magnetoelectric conversion element.

The GMR element is a layered or stacked product in the form of a so-called artificial lattice film, which is formed by alternately stacking a plurality of magnetic layers and a plurality of non-magnetic layers each of a thickness of a few angstroms to a few tens of angstroms, and (Fe/Cr)n, (permalloy/Cu/Co/Cu)n, and (Co/Cu)n (“n” is the number of stacked layers) are known as GMR elements. The GMR element has an MR effect (MR change rate) far greater than that of a conventional magnetoresistive element (hereinafter referred to as “MR element”), and the MR effect of the GMR element depends solely on a relative angle included by the directions of magnetization of the adjacent magnetic layers, so the GMR element is an in-plane magnetosensitive element that can obtain the same change in resistance with respect to the current flowing therethrough irrespective of the direction of an external magnetic field applied thereto relative to the direction of flow of the current. However, the GMR element can have magnetic anisotropy by narrowing the width of a magnetoresistive pattern.

In addition, the GMR element has hysteresis that exists in the change of the resistance value due to the change of the applied magnetic field, and also has a temperature characteristic particularly with a large temperature coefficient, as shown in the MR loop characteristic of the GMR element in FIG. 13.

In this manner, by using the GMR element as a magnetoresistive element, the signal-to-noise ratio (S/N ratio) can be improved, so noise immunity can be increased, thus making it possible to improve the detection accuracy.

Although in the above-mentioned respective embodiments, reference has been made to the examples in which each magnetic movable element is formed with two kinds of odd-shape portions having mutually different shapes, a magnetic movable element may have three or more kinds of odd-shape portions. In this case, comparison circuits and output circuits, which correspond in number to the odd-shape portions, are built into the processing circuit part.

In addition, although in the above-mentioned respective embodiments, reference has been made to the examples in which the magnetic movable element 1, 11, 21, 31, or 41 rotates around the rotation shaft 2, the present invention can of course be applied even to a magnetic movable element that is able to perform linear reciprocating motion.

Moreover, although in the above-mentioned respective embodiments, reference has been made to the case in which the magnetoresistive segment 3a is provided on the upper surface of the processing circuit part 4, the magnetoresistive segment 3a, though must be arranged in the vicinity of the magnet 5, need not necessarily be formed integral with the processing circuit part 4, but may of course be formed separately therefrom.

While the invention has been described in terms of preferred embodiments, those skilled in the art will recognize that the invention can be practiced with modifications within the spirit and scope of the appended claims.

What is claimed is:

1. A magnetic detection apparatus comprising:
a magnetic movable element that has at least two kinds of odd-shape portions of mutually different shapes;
a magnetoelectric conversion element that is arranged at a location apart from said magnetic movable element so as to come in opposition to one of said odd-shape portions differing in accordance with said moving magnetic movable element;
a magnet that is arranged in the vicinity of said magnetoelectric conversion element for applying a magnetic field to said magnetoelectric conversion element; and
a processing circuit part that generates different output signals in accordance with a change of said magnetic field applied to said magnetoelectric conversion element which is caused in accordance with said different odd-shape portions in opposition to said processing circuit part.

2. The magnetic detection apparatus as set forth in claim 1, wherein said magnetic movable element is of a disk shape, and said odd-shape portions comprise a first groove and a second groove formed in a peripheral portion of said magnetic movable element, said second groove being larger in diametral depth than said first groove.

3. The magnetic detection apparatus as set forth in claim 1, wherein said magnetic movable element is of a disk shape, and said odd-shape portions comprise a first groove and a second groove formed in a peripheral portion of said magnetic movable element, said second groove being larger in circumferential length than said first groove.

4. The magnetic detection apparatus as set forth in claim 1, wherein said magnetic movable element is of a disk shape, and said odd-shape portions comprise a pair of first opposed grooves and a pair of second opposed grooves formed in a peripheral portion of said magnetic movable element, said second grooves being larger in diametral depth than said first grooves.

5. The magnetic detection apparatus as set forth in claim 1, wherein said magnetic movable element is of a cylindrical shape, and said odd-shape portions comprise a first hole and a second hole formed in a peripheral portion of said magnetic movable element, said second hole being larger in axial length than said first hole.

6. The magnetic detection apparatus as set forth in claim 1, wherein said magnetic movable element is of a cylindrical shape, and said odd-shape portions comprise a first groove and a second groove notched in said magnetic movable element from one end face thereof, said second groove being larger in axial length than said first groove.

7. The magnetic detection apparatus as set forth in claim 1, wherein said respective output signals comprise a crank angle sensor signal and a cam angle sensor signal of an engine.

8. The magnetic detection apparatus as set forth in claim 1, wherein said magnetoelectric conversion element comprises a giant magnetoresistive element.
